(19) United States
(12) Patent Application Publication
(10) Pub. No.: US 2006/0047483 A1
(43) Pub. Date: Mar. 2, 2006

(54) System and method for automated verification of performance and budget goals in a process

(75) Inventors: Stephen Kafka, Medfield, MA (US); Igor Aronov, Needham, MA (US); Peter Govoni, Wilton, NH (US)

Correspondence Address: Global IP Services, PLLC;c/o PortfolioIP, P.O. Box 52050, Minneapolis, MN, 55402, US

(73) Assignee: Analog Devices, Inc.

(21) Appl. No.: 11/209,477

(22) Filed: Aug. 23, 2005

Related U.S. Application Data
(60) Provisional application No. 60/605,796, filed on Aug. 31, 2004.

(51) Int. Cl. G06F 11/30; G21C 17/00; G06F 15/00; G06F 13/10; G06F 9/44; G06F 13/12

(52) U.S. Cl. 702/186; 703/21

(57) ABSTRACT

A method (and system) for verification of performance and budget goals in a process, uses a feedback assisted automated system tuner with optional user guidance. A simulator with application and data interacts with the automated system tuner, by receiving tunable parameter changes from the system tuner and providing a feedback of budgets, goals and process inhibitors to the system tuner. The simulator has information incorporated therein relating to budgets and goals, as well as tunable system parameters, performance inhibitors and their associated relationships. For incorporating information into the simulator, a DMA descriptor may be used which allocates a channel between a peripheral memory and the simulator. The simulator produces a display showing system parameters and goals as compared to the actual performance. If goals are not met, the tuner uses a new set of parameters for the verification. The simulator also can generate source code for establishing system parameters.

### RELATED APPLICATIONS

Benefit is claimed under 35 U.S.C. 119(e) to U.S. Provisional Application Ser. No. 60/605,796, entitled “System and Method for Automated Iterative simulation Feedback Assisted Tuning and Verification of Performance and Real-time Budget Goals” by Stephen Kafka et al., filed Aug. 31, 2004, which is herein incorporated in its entirety by reference for all purposes.

### FIELD OF THE INVENTION

This invention generally relates to system and method for system verification and tuning tools for an architect's simulation of system performance and real-time budget goals. More particularly, the invention relates to such a system and method which uses iterative and simulation feedback assisted system verification and tuning for performance and budget goal verification in a process.

### BACKGROUND OF THE INVENTION

As increasingly complex System-On-Chip (SoC) architectures address ever more demanding system requirements, the difficulty of the task of the system architect in tuning his system to a given architecture has increased also. Modern simulation tools need do more to assist the architect in this endeavor. Improved automated, iterative, simulation feedback assisted, system verification and tuning tools would help with the verification and tuning of the architect's system performance and real-time budget goals.

Many complex interrelated system parameters affect the real-time performance and throughput of a dynamic system. In these dynamic systems it is difficult to statically determine if real-time budgets and data throughput goals will be met in the context of the running system on a given system architecture.

There exist prior art simulation environments that incorporate visualization techniques. Two examples are:
CoWare's Convergen SC Bus Contention Viewer, and,
Cadence Verilog Simulation Environments.

System simulation in and of itself has been a well discussed topic for several decades. Recently however, many SoC simulation environments have been made available, but these are simulation-only environments.

Another publication providing background information is “Transaction Level Modeling in System C”, by Adam Rose, Stuart Swan, John Pierce, Jean-Michel Fernandez, Cadence Design Systems, Inc.

Yet another publication which may be of interest is:
Tuning SoC Platforms for Multimedia Processing: Identifying Limits and Tradeoffs, by Alexander Maxiaguine, Yongxin Zhu, Samarjit Chakraborty, and Weng-Fai Wong in Computer Engineering and Networks Laboratory, ETH Zurich, Department of Computer Science, National University of Singapore.

Some publications regarding automated tuning environments are directed to only specific targets with no flexibility. For example, the following paper discusses automated tuning of two level caches: Design, Automation, and Test in Europe archive, Proceedings of the conference on Design, Automation and Test in Europe, Page: 10208, Year of Publication: 2004, ISBN:0-7695-2085-5-1

### SUMMARY OF THE INVENTION

The invention teaches a system and method for feedback assisted verification of performance and budget goals in a process. The method advantageously may use a feedback assisted automated system tuner with optional user guidance. Preferably, the system tuner has certain information incorporated relating to budgets and goals, as well as tunable system parameters, performance inhibitors and their associated relationships. In a preferred form of the invention, a simulator with application and data interacts with the automated system tuner, by receiving tunable parameter changes from the system tuner and providing a feedback of budgets, goals and process inhibitors to the system tuner. The simulator has the capability of producing a display showing system parameters and goals as compared to the actual performance. The simulator has also the ability to generate source code for establishing system parameters. Several embodiments of the invention with modifications of the components are conceivable and are envisaged to be within the ambit of the invention.

In one form, the invention relates to a method for verification of performance and budget goals in a system, comprising: performing an iterative simulation of system performance in a feedback assisted automated system tuner using a current set of tunable system parameters; ascertaining if budget goals are met to an acceptable degree; and if not, initiating changes in said tunable system parameters to arrive at a new set of parameters; and, continuing iterative simulation of system performance using said new set of parameters.

The parameters may include system goals, inhibitors impeding verification/performance, tunable parameters, and possible enabling actions/solutions. When changes in the tunable system parameters are initiated, the new set of parameters is presented for approval before use, after selective edits by a user. Alternatively, the new set of parameters may be subjected to modification before approval for selective edits by a user. The method might include the step of collecting data during system simulation across multiple real data sets and iterative simulations to assist in determining if budgets and goals are being met. Additionally, the method might include the step of a user entering system goals into the simulator by assigning a throughput goal to a DMA descriptor which allows a channel between a peripheral device and a memory in the simulator. The inhibitor data might include lack of ability to adequately meet the budget or other goal which would affect the system, to determine and apply a proper solution.

In a second form, the invention resides in a system for verification of performance and budget goals in a process, comprising: a simulator means for performing an iterative simulation of system performance in a feedback assisted automated system tuner using a current set of tunable system parameters; means ascertaining if budget goals are met to an acceptable degree; and if not, means for initiating changes in said tunable system parameters to arrive at a new set of parameters; said simulator means continuing iterative simulation of system performance using said new set of parameters.

### BRIEF DESCRIPTION OF THE DRAWING

A more detailed understanding of the invention may be had from the following description of embodiments, given by way of example and to be understood in conjunction with the accompanying drawing wherein like reference characters refer to like elements throughout the several views where applicable, in which:

FIG. 1 is an exemplary schematic of an automated iterative simulation feedback system tuner applied to the present invention; and,

FIG. 2 shows a general purpose computing platform which may be used in the practice of the present invention.

### DETAILED DESCRIPTION

In the following detailed description of implementations of the invention, reference is made to the accompanying drawings that form a part hereof, and in which are shown by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is therefore not to be taken in a limiting sense, and the scope of the present invention is defined only by the appended claims and their equivalents.

The following description provides a system and method for feedback assisted verification of performance and budget goals in a process. In the following description, the architecture and its inhibitors, and the goals and budgets of the system will be described first and these will be provided as inputs to the “automated iterative simulation feedback assisted system tuner”, or “system tuner” as explained in the remainder of this document, as follows:

System goals are related to goals including:
data transfer goals (throughput requirements);
key algorithm real-time performance budget goals; and,
power consumption budget goals.

The automated system tuner handles parameters, which for example include:
1. Inhibitors—(which impede system goals supported) including but not limited to execution speed, data throughput, bus collision, bank collision, preemption, pipeline hazard; fetch delays, data access delays, and inability to meet budget or goal.
2. Tunable system parameters, which include for example:
bus/channel assignment of transfer, location of buffer;
cache on/off, preload cache, lock cache way;
channel priority, register allocation.
3. Solutions—pertaining to relationship of inhibitors and tunable system parameters, including for example:
bus/channel assignment of transfer (bus collision);
location of buffer (bank collision);
cache on/off (fetch delays);
preload cache (initial fetch or data delays)
lock cache way (cache collision);
channel priority (preemption);
register allocation (pipe hazard).

Inhibitors, tunable system parameters, and solutions can be incorporated as inputs into the simulator as described above. The user can enter system goals by interacting with the simulator. For example, this can be done by selecting a suitable algorithm and assigning a real-time budget to it or assigning a throughput goal to a DMA descriptor, which allocates a channel between a peripheral and memory.

Application parts that have allocated goals can be made to stand out in the simulator with highlighting, icons, or other graphical indications and, information can be seen regarding related inhibitors and current actual vs. goal information at the site of the established goal in a context-sensitive fashion in addition to the separate aggregated display of this information.

Data will be collected during simulation of the system across multiple real datasets and iterative simulations to determine if budgets and goals are being met. Progress towards budgets and goals will be displayed along with the current set of tunable system parameters. In areas where budgets or goals are not met, an automated analysis of the performance and throughput inhibitors related to a given failure will produce changes in tunable system parameters. These will be presented for approval or modification, and another iteration of the simulation will be performed with the new system parameters.

The relationship between tunable system parameters and inhibitors is a key input to the system tuner for the verification process. This process of verification can be continued until the goals and budgets are met or all automated possibilities are exhausted. This provides verification (i) that system goals and budgets are met and (ii) that tuning assistance present when both goals and budgets are missed.

In order to accomplish this verification, the simulator is preferably enhanced such that the user can associate budgets or goals with algorithms or transfers respectively. During simulation, when the algorithm or transfer occurs, all inhibitor activity related to a system goal is generally associated with
1. the appropriate goal,
2. the uniquely identified and reproducible simulation, and,
3. the current tunable system parameters set.

The simulator will track the performance of the system goal and in real time, record any performance inhibitors related to its progress. This information will be fed back into the system tuner which will adjust the tunable system parameters based on which the performance inhibitors caused a goal to be missed.

Data collected during a given simulation is associated with a specific set of tunable system parameters. Additionally, all inhibitor and performance data is associated with specific system goals and uniquely identifiable and reproducible simulations. This avoids dead-lock of the system tuner because the set of tunable parameters is finite. Thus, any sets which become repeated can be detected. For each such set, the user can view information regarding goals vs. actual for each goal within each simulation (because different simulations may use different datasets to properly verify the system performance).

The following example helps illustrate the implementation of an embodiment of the present invention. Preferably, a system possessing DMA (direct memory access) capability between a peripheral and internal memory and the user's system establishes a throughput goal over this channel. Further, assuming that this hypothetical system has another slower, higher priority, DMA channel also exists. It is presumed that this exemplary system processes data on both the channels. The following exemplary sequence describes how a user, a simulator, and a system tuner can cooperate to verify whether the established system goal is met or if any further tuning is required.

User establishes throughput goal associated with their lower priority DMA transfer.

User or system tuner establishes values for tunable system parameters (initial values could be the reset values for the architecture.

User loads the application into the simulator.

User runs the simulation using the established tunable system parameters.

Simulator collects and stores all inhibitor data for the simulation and associates it with the current set of tunable system parameters and also the simulation itself. Simulation is uniquely identified so that multiple data sets can be verified and accountability can be maintained.

The collected ‘simulation feedback’ data is then sent to the system tuner for analysis and verification of system goals.

The system tuner detects any failure to meet the DMA transfer goal and determines that preemption (by the other DMA channel) can be the dominant inhibitor associated with this goal.

The system tuner proposes altering the priority of the DMA channel with the failed transfer to compensate, because channel priority is a tunable system parameter associated with a preemption failure in this hypothetical system.

Optionally, the user can approve a new set of tunable system parameters, possibly after additional edits.

The new set of tunable system parameters is then established for a next simulation.

Code is produced for inclusion in the user's application to establish the new tunable system parameters.

The user's application is rebuilt and reloaded with the new tunable system parameters established.

Simulation is run again and uniquely identified. This simulation is associated with the new set of tunable system parameters as well as all inhibitor information collected during the run.

The collected ‘simulation feedback’ data is then sent to the system tuner for analysis and verification of system goals.

If all the established time goals are met, then the user can generate the source code to establish these settings in the system.

The user can then select the current tunable system parameters and uniquely identified simulation and display the actual performance of the transfer versus the established goal to verify whether the established goal is met.

Implementation and further use of the collected data: One of the features of the described approach is organization of the data collected such that all data is associated with a specific tunable system parameter set (TSPS) and a uniquely identified simulation (which can be reproduced). In each simulation for a given TSPS, inhibitor data and performance data for system goals are collected. This data can be scrolled and manipulated in various ways to examine the actual performance information for each goal as plotted against the specified goal (actual vs. goal display). Moving forward or backward through these sets of tunable system parameters, the user can identify trends in performance goals and make more intelligent parameter changes based on a detailed understanding of the system.

Additionally, the system tuner can make comparative analysis (including as to whether performance is approaching the goal, and if so at what rate? Is the established rate increasing or decreasing?) as the tunable system parameters are changed to enrich the tuning recommendations made. Also, the system tuner and simulator can be setup to run for a period of time or number of simulations in an automated mode, seeking a TSPS that will meet all established goals. Results of these automated iterations can be easily grasped by the user scrolling through TSPS changes and corresponding actual vs. goal displays.

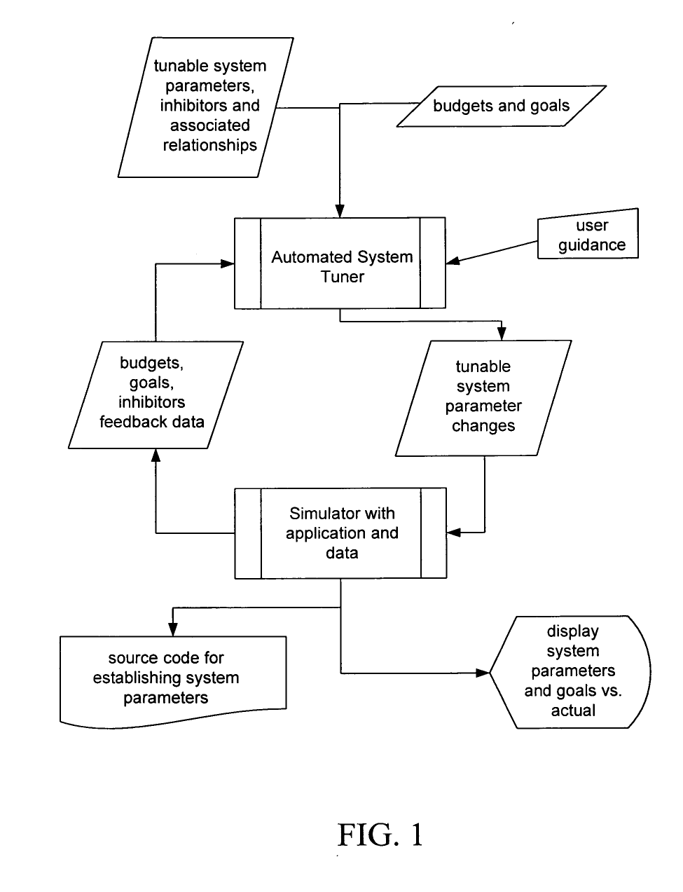

FIG. 1 illustrates an exemplary flow diagram of the present verification process and includes an automated system tuner which can receive inputs from budgets and goals, tunable system parameters along with inhibitors and associated relationships, user guidance, and feedback information from budgets, goals and inhibitors. As stated earlier, the automated system tuner performs an iterative simulation of the system performance with assisted feedback and using a current set of tunable system parameters. The automated system tuner is able to generate tunable parameter changes that can be used by the simulator through which a user may enter data and system goals as required. The simulator produces feedback data relating to budgets, goals and inhibitors, to be fed back in a loop to the automated system tuner. The simulator interacts with a display which shows system parameters and the goals status. The simulator is also configured to generate a desired source code for establishing system parameters. The flow diagram illustrated in FIG. 1 is by way of example only, and admits modifications within the ambit of the described embodiment.

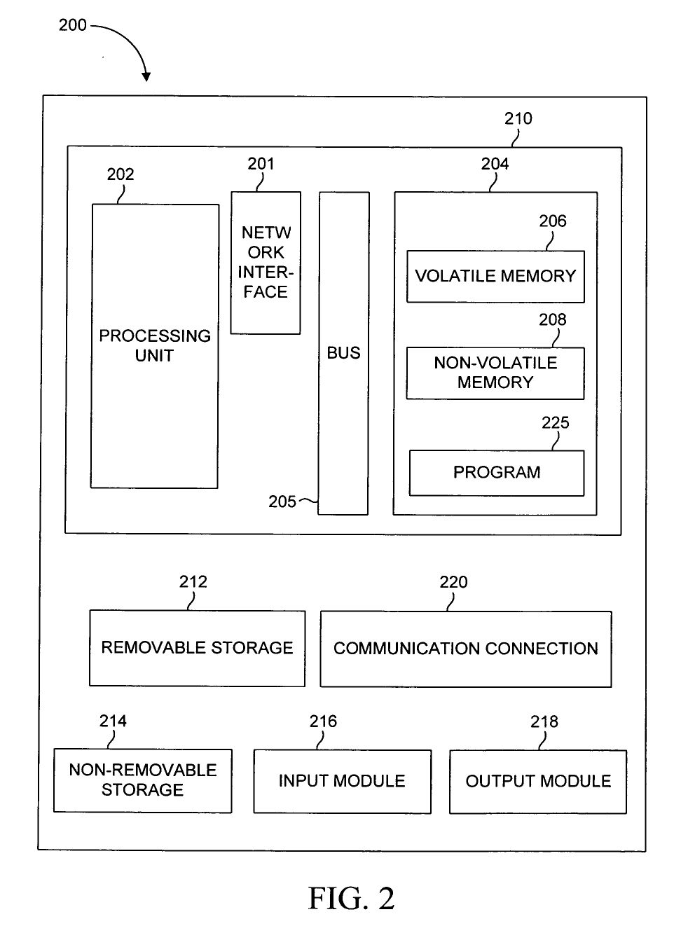

FIG. 2 shows an example of a suitable computing system environment for implementing embodiments of the present subject matter. FIG. 2 and the following discussion are intended to provide a brief, general description of a suitable computing environment in which certain embodiments of the inventive concepts contained herein may be implemented.

A general computing device 200, comprises a computer 210, and may include a processing unit 202, memory 204, removable storage 212, and non-removable storage 214. Computer 210 additionally includes a bus 205 and a network interface (NI) 201.

Computer 210 may include or have access to a computing environment that includes one or more user input devices 216, one or more output devices 218, and one or more communication connections 220 such as a network interface card or a USB connection. The one or more user input devices 216 can be a touch screen and a stylus and the like. The one or more output devices 218 can be a display device of computer, computer monitor, TV screen, plasma display, LCD display, display on a touch screen, display on an electronic tablet, and the like. The computer 210 may operate in a networked environment using the communication connection 220 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 204 may include volatile memory 206 and non-volatile memory 208. A variety of computer-readable media may be stored in and accessed from the memory elements of computer 210, such as volatile memory 206 and non-volatile memory 208 interacting with removable storage 212 and non-removable storage 214. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like, chemical storage, biological storage, and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 202 of the computer 210. For example, a computer program 225 may include machine-readable instructions capable of verification of system performance and system budget goals and as described hereinbefore with respect to preferred embodiments. In one embodiment, the computer program 225 may be included on a CD-ROM and loaded from the CD-ROM to a hard drive in non-volatile memory 208. The machine-readable instructions cause the computer 210 to decode according to the various embodiments of the present subject matter.

In the foregoing detailed description of embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. The description is intended to cover all alternatives, modifications and equivalents as may be included within the spirit and scope of the invention as defined in the appended claims. Many other embodiments will be apparent to those of skill in the art upon reviewing the above description. The scope of the invention should therefore be determined with reference to the appended claims, along with the full scope of equivalents to which such claims are entitled.

1. A method for verification of performance and budget goals in a system, comprising:
performing an iterative simulation of system performance in a feedback assisted automated system tuner using a current set of tunable system parameters;
ascertaining if budget goals are met to an acceptable degree; and if not, initiating changes in said tunable system parameters to arrive at a new set of parameters; and;
continuing iterative simulation of system performance using said new set of parameters.

2. The method as in claim 1, wherein said step of initiating changes includes presenting said new set of parameters for approval before use, after selective edits by a user.

3. The method as in claim 1, wherein said step of initiating changes includes presenting said new set of parameters for modification before use, after selective edits by a user.

4. The method as in claim 1, wherein said system parameters relate to system goals, inhibitors impeding verification/performance, tunable parameters, and possible enabling actions/solutions.

5. The method as in claim 4, including using a simulator through which a user can enter system goals to assist the performance.

6. The method as in claim 5, including the step of obtaining feedback regarding inhibitor data and budget goals from said simulator, and furnishing said feedback of said automated system tuner.

7. The method as in claim 4, including the step of a user entering system goals into the simulator by assigning a throughput goal to a DMA descriptor which allows a channel between a peripheral device and a memory in said simulator.

8. The method as in claim 7, including incorporating information relating to system goals, inhibitors, tunable parameters and possible enabling actions into said simulator.

9. The method as in claim 8, including the step of providing highlightable icons in said simulator to show application parts that have allocated goals.

10. The method as in claim 9, including the step of displaying real time performance and budget goals in the simulator.

11. The method as in claim 8, including the step of collecting data during system simulation across multiple real data sets and iterative simulations to assist in determining if budgets and goals are being met.

12. The method as in claim 11, wherein data collected during a given simulation is associated with a specific set of tunable parameters.

13. The method as in claim 8, including DMA transfers and including the step of detecting a failure to meet a DMA transfer goal.

14. The method as in claim 11, including the step of selectively sending collected simulation feedback data and other applicable inhibitor data to the system tuner for analysis and verification of system goals.

15. The method as in claim 1, wherein, if time goals are met, the method includes the step of the user generating source code to establish settings in the system.

16. The method as in claim 11, including the step of associating collected data with a specific tunable parameter set (TSPS) and a uniquely identifiable reproducible simulation.

17. The method as in claim 16, including the step of a user examining a plurality of TSPSs to identify trends in performance goals and make intelligent parameter changes.

18. The method as in claim 4, wherein system goals include: data transfer goals (throughput requirements), key algorithm real-time performance budget goals and power consumption budget goals; inhibitors include: bus-collision, bank-collision, preemption, pipeline hazard, fetch delays, inability to meet budget or goal, and data access delays; tunable system parameters include: bus/channel assignment of transfer, location of buffer, cache on/off, preload cache, lock cache way, channel priority, and register allocation; and possible enabling actions/solutions include: bus/channel assignment of transfer (bus collision), location of buffer (bank collision), cache on/off (fetch delays), preload cache (initial fetch or data delays), lock cache way (cache collision), channel priority (preemption), and register allocation (pipe hazard).

19. The method as in claim 5, including the step of tracking system performance and identifying any inhibitors related to system performance progress, and including adjusting tunable system parameters based on said identified inhibitors in real time.

20. The method as in claim 1, configured as an automated iterative simulation feedback system tuner by using software.

21. An article comprising a storage medium having instructions thereon which when executed by a computing platform result in execution of a method for verification of performance and budget goals in a system, comprising:
performing an iterative simulation of system performance in a feedback assisted automated system tuner using a current set of tunable system parameters;
ascertaining if budget goals are met to an acceptable degree; and if not,
initiating changes in said tunable system parameters to arrive at a new set of parameters; and;
continuing iterative simulation of system performance using said new set of parameters.

22. A system for verification of performance and budget goals in a process, comprising:
a simulator means for performing an iterative simulation of system performance in a feedback assisted automated system tuner using a current set of tunable system parameters;
means ascertaining if budget goals are met to an acceptable degree; and if not,
means initiating changes in said tunable system parameters to arrive at a new set of parameters;
said simulator means continuing iterative simulation of system performance using said new set of parameters.

23. A method for verification of performance and budget goals in a system, based on system parameters relating to system goals, inhibitors impeding verification/performance, tunable parameters, and possible enabling actions/solutions, said method comprising:
performing an iterative simulation of system performance in a feedback assisted automated system tuner using a current set of tunable system parameters;
ascertaining if budget goals are met to an acceptable degree; and if not,
initiating changes in said tunable system parameters to arrive at a new set of parameters;
continuing iterative simulation of system performance using said new set of parameters;
said method further including the steps of using a simulator through which a user can enter system goals to assist the performance; collecting data during system simulation across multiple real data sets and iterative simulations to assist in determining if budgets and goals are being are being met; and sending collected simulation feedback data to the system tuner for analysis and verification of system goals.

24. An article comprising a storage medium having instructions thereon which when executed by a computing platform result in execution of a method for verification of performance and budget goals in a system, based on system parameters relating to system goals, inhibitors impeding verification/performance, tunable parameters, and possible enabling actions/solutions, said method comprising:
performing an iterative simulation of system performance in a feedback assisted automated system tuner using a current set of tunable system parameters;
ascertaining if budget goals are met to an acceptable degree; and if not,
initiating changes in said tunable system parameters to arrive at a new set of parameters;
continuing iterative simulation of system performance using said new set of parameters;
said method further including the steps of using a simulator through which a user can enter system goals to assist the performance; collecting data during system simulation across multiple real data sets and iterative simulations to assist in determining if budgets and goals are being are being met; and sending collected simulation feedback data to the system tuner for analysis and verification of system goals.
